(19) United States
(12) Patent Application Publication
(10) Pub. No.: US 2015/0352380 A1
(43) Pub. Date: Dec. 10, 2015

(54) Descent Rescue Device with Double Brake and Back and Forth Controlled

(71) Applicant: Boyuan Huang, Guangzhou, Guangdong (CN)

(72) Inventors: Boyuan Huang, Guangzhou, Guangdong (CN); Qianjing Huang, Guangzhou, Guangdong (CN)

(73) Assignee: Boyuan Huang, Guangzhou, Guangdong (CN)

(21) Appl. No.: 14/760,485

(22) PCT Filed: Jun. 5, 2013
(86) PCT No.: PCT/CN2013/076747

§ 371 Date: Jul. 13, 2015

(30) Foreign Application Priority Data
Jan. 30, 2013 (CN) 201310035997.X

(51) Int. Cl. A62B 1/10

(52) U.S. Cl. CPC A62B 1/10

(57) ABSTRACT

A descent rescue device with double brake and back and forth controlled comprising an outer shell and a tyra mechanism, a double braking mechanism, and a line-guiding mechanism, the tyra mechanism is connected to the double braking mechanism and moving together, while the outer braking component in the state of no pressure or the biggest pressure, the inner braking component is to be in the state of riding the brake and producing damp in order to tighten and lock the steel wire rope wrapping around it. While the outer braking component in the state of half clutch, the lock of the steel wire rope by the inner braking component and the brake hub are in friction state, then the steel wire rope would be leaded from the line-guiding mechanism easily because of the frictional resistance, so as to achieve the purpose of slowing down from the high building.

### BACKGROUND OF THE INVENTION

1. Field of the Invention

The present invention relates to a descent rescue device, more especially related to a descent rescue device with double brake and back and forth controlled to realize save oneself and save others in the air.

2. Description of the Prior Art

Nowadays, there are more and more high buildings in the city. If the fire, the earthquake or the accident of sightseeing cable car happening, how can the people to escape securely from the high building? Because the extended height of the fire ladder is limited and the elevator is not allowed to be used, it is hard to solve that escaping from the high building and putting out the fire. At present, there are a variety of descent rescue device developed for escaping from high building, although, these descent rescue device have following defects: (1) the first, the descent rescue is heavy and big to carry; (2) the second, it could not be slow down and brake in the air; (3) the third, it is difficult control the state and falling speed; (4) the forth, the high-speed friction causes the wear and tear of internal components, even brings a lot of hidden dangers.

Because of the about defects and safety factors, the descent rescues are almost not applied in reality. Therefore, it is necessary to provide a descent rescue with high safety coefficient and good controllability.

### SUMMARY OF THE INVENTION

In order to overcome the defects, the main purpose of the present invention is to provide a descent rescue which could be slowed down many times back and forth from the high building by many people and be stopped at any position in the air by control.

To achieve the purpose of the invention, the present invention provides a descent rescue device with double brake and back and forth controlled comprising an outer shell, a tyra mechanism, a wedge wheel, a double braking mechanism and a line-guiding mechanism. The tyra mechanism comprises an energy conversion adjusting screw and a buffer installed the outer thereof, which is connected to the double braking mechanism and moving together. The double braking mechanism comprises an outer braking component, an inner braking component and a locking mechanism, the inner braking component is connected to the energy conversion adjusting screw of the tyra mechanism for moving together. A wedge wheel is provided for installed the outside surface of the inner braking component. A bundle of steel wire rope is wrapped around the wedge wheel. The locking mechanism is resisted movably between the outer braking component and the outer shell. While the outer braking component in the state of no pressure, the inner braking component is to be in the state of riding the brake and producing damp in order to tighten and lock the steel wire rope wrapping around it. While the outer braking component in the state of half clutch or full open, then the inner braking component would loosen the lock of the steel wire rope because of the damp and frictional resistance is weak, and then the steel wire rope would be leaded from the line-guiding mechanism easily.

When the tyra mechanism is located at the building and the free end of the steel wire rope is tied at the body who be saved, the people who be saved can drop along with the steel wire rope. When the free end of the steel wire rope is tied at the building and the tyra mechanism is tied around the body who are able to self-rescue, the people who are able to self-rescue can also drop to any place in air along with the descent rescue device.

In the present invention, the inner braking component comprises a main axis, the first braking block, a braking hub and the second braking block. The block closing rotation roller is connected to the energy conversion adjusting screw of the tyra mechanism, the brake hub is located between the friction block and the second braking block. During falling of the descent rescue device, the tyra mechanism is separated from the outer shell and the block linkage arm could be rotated by the pulling of the tyra mechanism, and two friction blocks located at the two side of the main axis is pressed onto the brake hub and the second braking block with an outward force. The friction of the first braking block, the brake hub and the second braking block is equal to the weight of people.

The center of main axis is located at middle of the shaft plate, two friction blocks are located at the two sides of the main axis symmetrically. Two block gap are located on the first braking block. Two friction blocks are embedded into two block gap. The two friction blocks are the first friction block and the second friction block. The first friction block is connected to the block linkage arm by the block closing rotation roller, and the block linkage arm is connected to the energy conversion adjusting screw of the tyra mechanism. During the falling of the descent rescue device, the middle part of block linkage arm drive the first friction block deflecting and making a micro-rotation in the block gap with the pulling of the energy conversion puller, in order to drive the first friction block to press the brake hub and the second braking block.

The outer braking component comprises a power handle and a helping handle. The locking mechanism is resisted between the power handle and the helping handle. The power handle is connected to the block linkage arm by the linkage arm. With no pressure on the power handle and the helping handle, the locking mechanism is assembled at the fixed bayonet and resisted between the power handle and the helping handle to keep the maximum angle. The brake hub press the second braking block to make the steel wire rope wrapped around it locked, so as to lock the steel wire rope wrapped around the wedge wheel, producing braking state to stop the release of steel wire rope. With the power handle and the helping handle are pressed to compress the locking mechanism to the minimum, the power handle could drive the linkage arm swaying together to push the block closing rotation roller rotating. The first friction block is pressed to bring friction between the first friction block and the brake hub so that the descent rescue device would keep in braking. If the locking mechanism is pressed a certain space, the outer braking component will be in a half clutch state, at the same time the descent rescue device at the braking state, the steel wire rope could be released limited from the outer braking component.

The locking mechanism comprise a brake-adjusting nut, a brake-tightening spring, a located block and a brake adjusting screw which run through the hole, the brake adjusting screw is fixed on the outer shell by the brake-adjusting nut, the brake-tightening spring is provided between the brake-adjusting nut and the braking assembly base, with no pressure on the outer braking component, the brake adjusting screw is always resisted between the power handle and the helping handle by the brake-tightening spring to keep the maximum angle.

The tyra mechanism comprises the energy conversion adjusting screw, the buffer, a hanging ring, a spring traction tube and a buffer tube. The buffer comprises an energy conversion spring and a buffer spring. The energy conversion spring is received between the energy conversion adjusting screw and the spring traction tube, and the buffer spring is received between the spring traction tube and the buffer tube, the hanging ring and the energy conversion adjusting screw are to be separately each other. When the saved man is slowing down at a certain speed, the energy conversion spring and the buffer spring would be compressed with the change of carrying weight. By setting the elasticity coefficient of the energy conversion spring and the buffer spring, the lowest loading capacity could be set. When the loading capacity is over 29 Kg, the descent rescue device could be used. The elastic restoring force of the energy conversion spring changes with the change of carrying weight. When the loading capacity reaches a certain number, the buffer spring would be deformed to take a buffer action in the slow falling process.

The line-guiding mechanism comprises a guide wheel, a sliding briquetting and a briquetting spring, wherein the guide wheel is assembled at the export of the outer shell, the sliding briquetting is assembled beside the guide wheel, the briquetting spring is provided for adjusting the limited of the sliding briquetting, which is inserted in the space between the in-wall of the outer shell and the sliding briquetting. The sliding briquetting is provided for limiting the steel wire rope and bringing the sliding friction between the steel wire rope and the sliding briquetting, the wedge wheel is rolling frictional, so the friction resistance between the steel wire rope and the wedge wheel will be maximum.

The guide angle of the wedge wheel is 25°-35° degree, prefer to be 30°. By putting the steel wire rope into the wedge wheel at an appropriate guide angle, the steel wire rope is no easy to slide down from the wedge wheel, so the saved man could go down safely.

The outer component and the line-guiding mechanism is attached at the different sides of the outer shell for avoiding the outer braking component influencing the retraction of the steel wire rope.

Compared with the prior art, a descent rescue device with double brake and Back and forth controlled in the present invention has advantages as follows:

In good control, the status and speed during the falling process could be controlled by adjusting the status of the outer braking component. With no pressure or the biggest pressure on the outer braking component, the inner braking component could produce a large friction to make the descent rescue device in braking state. That is to say, the descent rescue device will keep braking and no falling down automatic. If the pressure is appropriate, the steel wire rope could be released freely and then the saved man could fall on a constant speed. The design of the double braking mechanism is a major feature of the invention;

The first braking block serves the double purpose of producing damp to prevent saved man from doing free falling motion and serving as component with braking function to let saved man who is in panic can drop to any place in air by holding the power handle tightly to stop the descent rescue device on the falling process.

Multistage slow falling measures are set. For example, the spring produces a certain elastic restoring force for resisting the load gravity; the bigger the loading capacity of the device, the larger the elastic restoring force, then the deformation energy can be converted into the mechanical energy. Multistage friction components take braking action against falling, and the falling speed can be controlled at a constant speed if the weight is in the loading capacity range.

The device applies to both people who need help and who are able to self-rescue. When a fireman assists other people to reach the ground safely with the descent rescue device, he himself could use the device to go down safely. The descent rescue device is very practical.

Reset the easily worn components and outer braking component by spring. By setting springs in particular position, we can achieve real-time correction and retting of the easily worn components and outer braking component to avoid wear and tear or deviations or less safe. The mechanical resetting way both achieves the resetting of operational states and guarantee high accuracy for multi-time use.

### BRIEF DESCRIPTION OF THE DRAWINGS

FIG. 1 is a front section view of a descent rescue device with double brake and Back and forth controlled in the present invention;

FIG. 2 is a side section view of a descent rescue device with double brake and Back and forth controlled in the present invention;

FIG. 3 is a vertical section view of a descent rescue device with double brake and Back and forth controlled in the present invention;

FIG. 4 is a view of a descent rescue device with double brake and Back and forth controlled in the present invention under load state.

| | | | |
|---|---|---|---|
| descent rescue device with | 100 | outer shell | 1 |
| double brake and back and forth | | | |
| controlled | | | |
| tyra mechanism | 2 | adjusting screw | 20 |
| Buffer | 21 | energy conversion spring | 210 |
| buffer spring | 212 | hanging ring | 22 |
| spring traction tube | 23 | holder of traction tube | 230 |
| buffer tube | 24 | energy conversion puller | 25 |
| double braking mechanism | 3 | outer braking component | 30 |
| power handle | 301 | helping handle | 302 |
| linkage arm | 303 | adjusting bolt | 304 |
| inner braking component | 31 | main axis | 310 |
| block closing rotation roller | 310a | block linkage arm | 310b |
| handle linkage axis | 310c | the first friction block | 310d |
| The second friction block | 310e | block fixed pin | 310f |
| block gap | 311a | brake hub | 312 |
| the second braking block | 313 | braking rocker arm | 314 |
| braking arm hinge | 315 | locking mechanism | 32 |
| brake-pushing puller | 320 | brake-adjusting nut | 321 |
| brake-tightening spring | 322 | braking assembly base | 323 |
| line-guiding mechanism | 4 | guide wheel | 40 |
| sliding briquetting | 41 | briquetting spring | 42 |
| rope ring | 51 | rolled plate | 52 |
| wedge wheel | 6 | shaft plate | 7 |

### DETAILED DESCRIPTION OF PREFERRED EMBODIMENTS

### Detailed Description of the Invention

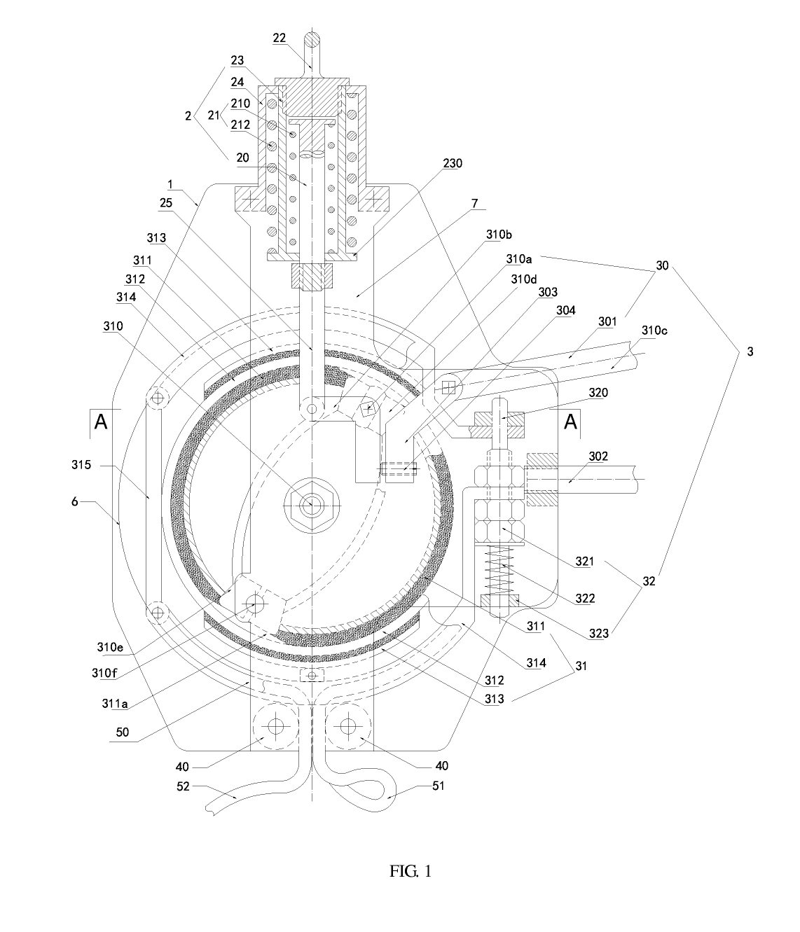

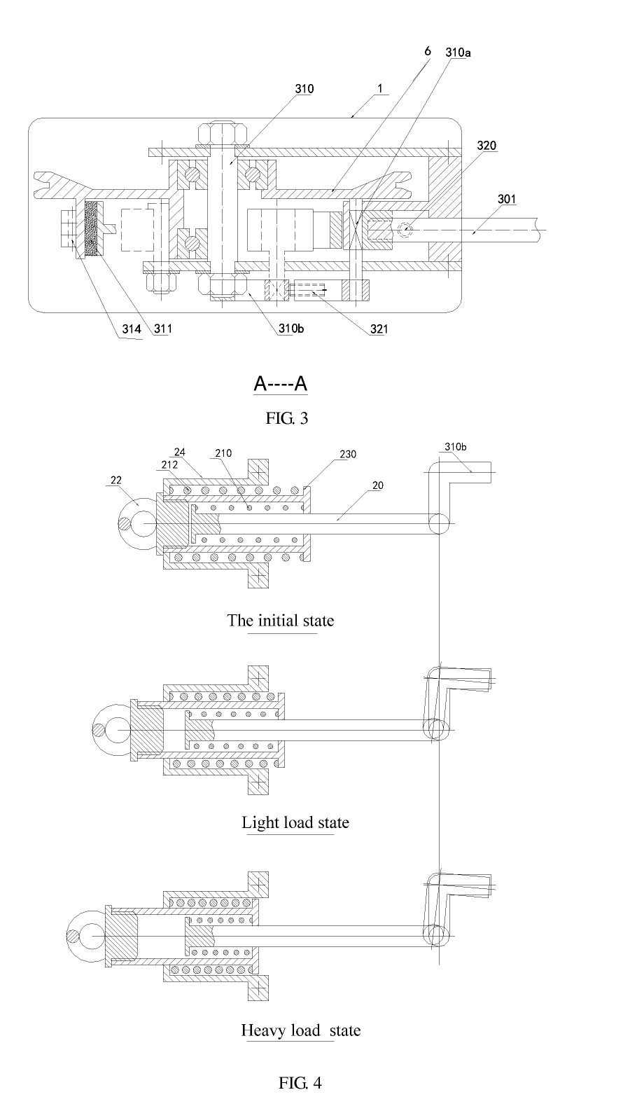

Refer to FIGS. 1-3, the present invention provides a descent rescue device with double brake and back and forth controlled 100 comprising an outer shell 1 and a tyra mechanism 2, a double braking mechanism 3, a line-guiding mechanism 4, a wedge wheel 6 installing inside the outer shell 1. The tyra mechanism 2 comprises an energy conversion adjusting screw 20 and a buffer 21 installed the outer thereof, which is connected to the double braking mechanism 3 and moving together. The double braking mechanism 3 comprises an outer braking component 30, an inner braking component 31 and a locking mechanism 32, wherein the inner braking component 31 is connected to the energy conversion adjusting screw 20 of the tyra mechanism 2 for moving together. A wedge wheel 6 is provided for installed the outside surface of the inner braking component 31. A bundle of steel wire rope 50 is wrapped around the wedge wheel 6. The locking mechanism 32 is resisted movably between the outer braking component 30 and the outer shell 1. While the outer braking component 30 in the state of no pressure or the biggest pressure, the inner braking component 31 is to be in the state of riding the brake and producing damp in order to tighten and lock the steel wire rope 50 wrapping around it. While the outer braking component 30 in the state of half clutch or full open, then the inner braking component 31 would loosen the lock of the steel wire rope 50 because of the damp and frictional resistance is weak, and then the steel wire rope 50 would be leaded from the line-guiding mechanism 4 easily.

The outer shell 1 is provided for covering all the components to carry conveniently. The whole weight of the descent rescue device 100 is about 3.4 Kg (no include the steel wire rope 50). The tyra mechanism 2 could be extended from the upped of the outer shell 1 and hanged on the high building. And then the outer braking component 30 could be extended from the outside of the outer shell 1, so that the descent rescue device 100 would be controlled in the state of braking or falling by pulling the outer braking component 30. The tyra mechanism 2 comprises the energy conversion adjusting screw 20, the buffer 21, a hanging ring 22, a spring traction tube 23 and a buffer tube 24. Therein, the buffer 21 is surrounded the energy conversion adjusting screw 20. The spring traction tube 23 and the buffer tube 24 are wrapping each other and the buffer 21 is separately set in it. The hanging ring 22 and the energy conversion adjusting screw 20 are to be separately each other, and the hanging ring 22 is extended from the upper of the tyra mechanism 2. If someone is rescued by the others, it is need to put the hanging ring 22 fixed onto the building; in the other case, if someone will save by oneself, then it is need to wrap the hanging ring 22 around himself and put the rope ring 51 hanged the building.

The buffer 21 comprises an energy conversion spring 210 and a buffer spring 212. The energy conversion spring 210 is received between the energy conversion adjusting screw 20 and the spring traction tube 23, and the buffer spring 212 is received between the spring traction tube 23 and the buffer tube 24. In the present embodiment of the invention, for assembling conveniently, the spring traction tube 23 and the buffer tube 24 are wrapping each other and connecting together to be a whole component. The spring traction tube 23 is acted to be an inner sleeve which wall is longer than that of the buffer tube 24. A holder of traction tube 230 is provided at the bottom of the spring traction tube 23, which is extended toward the inner and the outer of the spring traction tube 23. The energy conversion spring 210 is surrounded by the energy conversion adjusting screw 20, and one of free end of the energy conversion spring 210 is put pressure on the inside of the holder of traction tube 230. The buffer tube 24 is acted to be an outer sleeve. The buffer spring 212 is received in the circular cylinder which assembling by the spring traction tube 23 and the buffer tube 24, and one of free end of the buffer spring 212 is put pressure on the outside of the holder of traction tube 230. In the present embodiment, the elasticity coefficient of the buffer spring 212 is larger than that of the energy conversion spring 210, that is to say, the absorbed energy by the buffer spring 212 is greater than that of the energy conversion spring 210. With a proper process, the deformation coefficient of the buffer spring 212 is to be a small lever. The sum of the elastic restoring force with the buffer spring 212 and the energy conversion spring 210. With buffer action from the two spring, especially under the condition of overweight, for example when the descent rescue device is carried two people, the buffer spring 212 could absorb more energy in order to take a buffer action for the people be saved in the slow falling process. The main function of the energy conversion spring 210 is to convert the deformation energy into the mechanical energy. The mechanical energy is transmit from the energy conversion spring 210 and the energy conversion adjusting screw 20 and the energy conversion puller 25 to a block linkage arm 310b. A block closing rotation roller 310a and the first friction block 310d could be rotated by the block linkage arm 310b, then the frictional resistance between the first friction block 310d and the brake hub would amplify so as to achieve the purpose of slowing down from the high building.

Refer to FIG. 4, under the change of the load state of the descent rescue device, the energy conversion spring 210 of the tyra mechanism 2 and the buffer spring 212 would be compressed with the change of carrying weight. At the initial status with no loaded, the block linkage arm 310b is to be in a relaxed state, and the block linkage arm 310b would be rotated by the pulling of the energy conversion adjusting screw 20 and the energy conversion puller 25. And then, the energy conversion spring 210 would also be compressed by the pulling of a bulge on the top of the energy conversion adjusting screw 20 so as to balance the gravity of the loading and produce buffer in the falling process. If the loading is light, the buffer spring 212 would be not deformed; if the loading is larger, the energy conversion spring 210 would be deformed by the pulling of the energy conversion adjusting screw 20 continually. At this time, the buffer tube 24 would be moving down by the pulling of the whole descent rescue device and make the buffer spring 212 deform in compressed. And then, the buffer spring 212 and the energy conversion spring 210 would also to be deformed by compressed so that a great elastic restoring force could be produced for balancing the gravity of the loading to make someone slow down at constant speed. During the falling process, the energy conversion spring 210 and the buffer spring 212 are acted as a buffer component. For best results, the falling speed is to be controlled between 0.16-3 m/s.

For preventing the accidence, a series of security and restrictive constraints should be set to the descent rescue device. The descent rescue device is provided to be used by adult not by children oneself. In the embodiment of the present invention, the lowest loading capacity would be limited at 29 Kg. Therefore the adult whose weight is over 29 Kg could use the descent rescue device by himself. The child whose weight is less than 29 Kg should slow down using the descent rescue device accompanying with an adult. If the loading capacity is less than 29 Kg, then the descent rescue device would keep in the initial braking state and the steel wire rope could not be exported. When the tyra mechanism 2 is located at the building and the free end of the steel wire rope is tied at the body who be saved, the people who be saved can drop along with the steel wire rope. When the free end of the steel wire rope is tied at the building and the tyra mechanism 2 is tied around the body who be saved, the people who be saved can also drop to any place in air along with the descent rescue device. The loading capacity of the descent rescue device is adjusted by energy conversion with the energy conversion adjusting screw.

The inner braking component 31 comprises a main axis 310, the first braking block 311, a braking hub 312 and the second braking block 313. The first braking block 311, a braking hub 312 and the second braking block 313 are covering around the main axis 30 one by one. The shape of the main axis 310 is an oval. The center of main axis 30 is located at middle of the shaft plate 7 by screw. The upper part of the main axis 310 is connected to the energy conversion puller 25. The axletrees beside the main axis 310 are provided for holding up the wedge wheel and brake hub 312. The energy conversion puller 25 is positioned inside the energy conversion adjusting screw 20 of the tyra mechanism 2 for moving together synchronously. The main axis 310 would be rotated and shifted with the pulling by the energy conversion adjusting screw 20. Two friction blocks is located at the two side of the main axis 310 symmetrically. The two friction blocks are the first friction block 310d and the second friction block 310e which to be fixed onto the shaft plate 7 respectively. The first friction block 310d is connected to the block linkage arm 310b by the block closing rotation roller 310a, and the block linkage arm 310b is connected to the energy conversion adjusting screw 20 of the tyra mechanism 2. The shape of the block linkage arm 310b presents “L”. The end of the block linkage arm 310b is assembled on the energy conversion puller 25 and the middle part is fixed on the first friction block 310d. Two block gap 311a are respectively located on the two end of the main axis 310. The diameter of the block gap 311a is equal to that of the first friction block 310d and the second friction block 310e. The second friction block 310e is embedded into the other block gap 311a and fixed on the shaft plate 7 by block fixed pin 310f, and then the second friction block 310e could not be rotated with the main axis 310 to ensure the first friction block 310d press on the first braking block 311 during the falling state. The middle of block linkage arm 310b is like cam. When the loading capacity reach a certain weigh, during the falling of the descent rescue device, the middle part of block linkage arm 310b is rotating and expanding outside to drive the first friction block 310d deflecting and making a micro-rotation in the block gap 311a with the up and down pulling of the energy conversion puller 25, in order to drive the first friction block to press the brake hub 312 and the second braking block 313 and then the friction resistance of the first friction block 310d and the brake hub 312.

The friction block is covered closed by the brake hub 312, and the friction block also is covered closed by the second braking block 313. The brake hub 312 is located between the friction block and the second braking block 313. The second braking block 313, the brake hub 312 and the first braking block 311 are formed to two groups brake mechanisms with covering together, which play the braking effect at different conditions during the falling of the descent rescue device. During falling of the descent rescue device, the tyra mechanism 2 is separated from the outer shell 1 and the main axis 310 could be rotated by the pulling of the tyra mechanism 2, and the main axis 310 is pressed onto the two sides of the first friction block 310d, and then the first friction block 310d is pressed onto the brake hub 312 and the second braking block 313 with an outward force. The friction of the first braking block 311, the brake hub 312 and the second braking block 313 is equal to the weight of people. The friction between the first braking block 311 and the brake hub 312 and the second braking block 313 is directly proportional to the weight of people. That is to say, if the people is heavier, the friction is greater. In the present invention, the rotate angle range of the first friction block 310d is 2-3 degree. The input power is proportional to the loading capacity. The increase of the load could be converted into a larger frictional force.

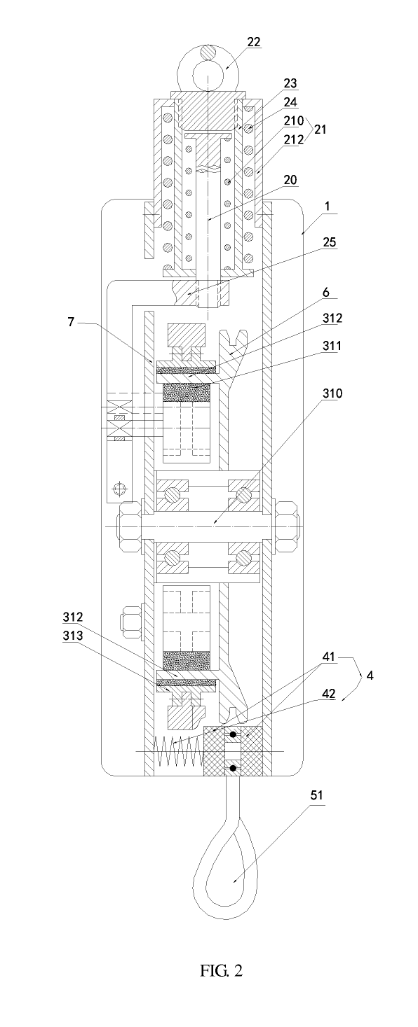

Refer to FIG. 2, a braking rocker arm 314 and a braking arm hinge 315 is provided for surrounding the second braking block 313 of the inner braking component 31. The steel wire rope 50 is surrounded the periphery of the second braking block 313 and to be lead from the line-guiding mechanism 4. Under the braking control of the inner braking component 31, the rotation of the wedge wheel 6 would be control in order to adjust the retraction of the steel wire rope 50. In a embodiment of the present invention, the guide angle of the wedge wheel is 25°-35° degree, prefer to be 30°. The purpose of the guide angle is to make the steel wire rope no easy to slide down from the wedge wheel 6. The steel wire rope 50 could be nestled up more closed to the inner-wall of the wedge wheel 6 with the falling speed increasing to prevent the slipping of the steel wire rope. The value of sliding friction depends on the size of the guild angle. The length of steel wire rope 50 depends on the height of the building, so that it could be optional assembled. The rolled plate 52 is located outside the descent rescue device. The steel wire rope 50 could be cut out quickly with the rope ring 51.

The outer braking component 30 comprises a power handle 301 and a helping handle 302. The locking mechanism is resisted between the power handle and the helping handle The power handle 301 is assembled above the outer braking component 30. While pulling the power handle 301 downward, the falling state and speed of the descent rescue device could be adjusted with different power by pulling the power handle 301. When the speed is more than 3 m/s, the falling speed would also be to keep in the controlled range with the friction between the first braking block and brake hub. The helping handle 302 is fixed onto the shaft plate 7 and to be keep still toward the power handle 301. The power handle 301 is connected dynamically to the block linkage arm 310b by the linkage arm 303, and the linkage arm 303 is assembled at the end of the handle linkage axis 310c, which one end is connected to the power handle 301 and the other end is inserted into the inner braking component 31 closed the main axis 310. As the pulling of the power handle 301, the linkage arm 303 will be moving toward the opposite direction. The swing track is enlarged with the increasing of the force from the power handle 301. As the pressure on the power handle 301 is to be the maximum, the pressure on the outer braking component 30 would be converted to the friction of the inner braking component 31. The end of the linkage arm 303 is resisted to the block closing rotation roller 310a so as to press it rotate in a micro angle. With the rotation of the block closing rotation roller 310a, the first friction block 310d would be press on the brake hub 312 to stop the descent rescue device falling. Set the initial state of the outer braking component to be the braking state. Push the power handle 301 down, then the second braking block 313 and the brake hub would loosen the wedge wheel 6, and then the steel wire rope 50 would be lead out with the rotation of the wedge wheel 6 and the descent rescue device would be falling down slowly. Release the power handle 301, the descent rescue device would be reset return to the braking state.

For adjusting the gap between the linkage arm 303 and the block linkage arm 310b, an adjusting bolt 304 is provided at the bottom of the linkage arm 303 which is inserted the inner braking component. The gap of the linkage arm 303 and the block closing rotation roller 310a could be narrow or expanse with rotating the adjusting bolt 304 according to adjust the relation between the outer braking component 30 and the inner braking component 31. To shorten the gap of the linkage arm 303 and the block closing rotation roller 310a with rotate the adjusting bolt 304, the pressure on the power handle 301 would be reduced. The linkage arm 303 would be more closed and resisted to the block closing rotation roller 310a by the power handle 301 to drive the braking of the inner braking component. The gap of the adjusting bolt 304 and the block closing rotation roller 310a would be controlled for adjusting the sensitivity and the reliability of the descent rescue device, and the linkage arm 303 could be connected dynamically to the block closing rotation roller 310a by the adjusting bolt 304 for reducing the contact area and accordingly preventing the mechanical friction influencing the braking performance. If the adjusting bolt 304 or the block linkage arm 310b is wear, that the adjusting bolt 304 could be changed only so as to reduce the material breakage and the maintenance cost.

A fixed bayonet is provided at the one side of the braking rocker arm 314. With no pressure on the power handle 301 and the helping handle 302, the locking mechanism 32 is assembled at the fixed bayonet and resisted between the power handle 301 and the helping handle 302 to keep the maximum angle. The locking mechanism 32 is used to lock the power handle 301 and the helping handle 302 for keeping the decent rescue device braking on the initial state of the outer braking component. The locking mechanism 32 comprises a brake-pushing puller 320, a brake-adjusting nut 321, a brake-tightening spring 322 and a braking assembly base 323. The brake-pushing puller 320 is run through the hole of the fixed bayonet and fixed on the helping handle 302 with the brake-adjusting nut 321. The braking assembly base 323 is assembled on the brake-pushing puller 320. For the resetting of the helping handle 302, the brake-tightening spring 322 is provided between the brake-adjusting nut 321 and the braking assembly base 323. With no pressure on the brake-pushing puller 320, the power handle 301 and the helping handle 302 are always resisted and extended to each other by the resetting of the brake-tightening spring 322. At the braking state with no pressure, if someone wants to drop down by the descent rescue device, he can press on the power handle 301, then the power handle 301 can push the brake-pushing puller 320 to open the first braking block 311, and then the wedge wheel 6 can be rotated to lead down the steel wire rope when the first braking block 311 and the brake hub 312 are separated.

If the power handle 301 is at freedom state, without press the power handle 301, the brake hub 312 and the second braking block 313 will lock together to keep the decent rescue device braking. With the power handle 301 and the helping handle 302 are pressed to compress the locking mechanism 32 to the minimum, the power handle 301 could drive the linkage arm 303 swaying together to push the block closing rotation roller 310a rotating. The first friction block 310d is pressed to bring friction between the first friction block 310d and the brake hub 312 so that the descent rescue device would keep in braking. If the locking mechanism 32 is pressed a certain space, the outer braking component 30 will be in a half clutch state, at the same time the descent rescue device at the braking state, so there are not friction producing among the first friction block 310d, the brake hub 312 and the second braking block 313. Because of the friction damping between the brake hub 312 and the first braking block 311 in loading, the steel wire rope 50 could be released limited from the outer braking component 30. The rotation of the wedge wheel 6 depends on the action of the outer braking component 30. The steel wire rope 50 will be released with the rotation of the wedge wheel 6. And the rotation rate of the wedge wheel 6 depends on the size of the friction resistance and the power of gravity. The falling speed could be controlled by the power handle 301 according to the size of the required pressure on. When the friction between the first friction block 311 and the brake hub 312 is greater than the weight of the loading, the descent rescue device would be turn into the braking state and then the wedge wheel be not rotate the steel wire rope 50 to release.

The line-guiding mechanism 4 comprises a guide wheel 40, a sliding briquetting 41 and a briquetting spring 42, wherein the guide wheel 40 is assembled at the export of the outer shell 1, the sliding briquetting 41 is assembled beside the guide wheel 40, the briquetting spring 42 is provided for adjusting the limited of the sliding briquetting 41, which is inserted in the space between the in-wall of the outer shell 1 and the sliding briquetting 41. With the adjusting of the guide wheel 40 and the sliding briquetting 41, the release tract of the steel wire rope 50 could be limited to avoid fraying from the friction between the steel wire rope 50 and through hole. If the sliding briquetting 41 is frayed, the briquetting spring 42 will compensate the gap producing by frayed through the dynamic compensation for keeping effective friction resistance. At the same time, the sliding friction resistance could be increased by the sliding of the sliding briquetting 41 for not only preventing the steel wire rope slipping during the releasing and retracting of the steel wire rope, but also adjusting the resetting of the sliding briquetting 41 by the briquetting spring 41 to strengthen the restriction of the steel wire rope, so that the sliding briquetting 41 could retain the pressure on the steel wire rope 50 with long time using. The sliding briquetting 41 is provided for limiting the steel wire rope and bringing the sliding friction between the steel wire rope and the sliding briquetting 41, so that the friction resistance will be retained between the steel wire rope and the wedge wheel to prevent the steel wire rope slipping. The guide wheel 40 is provided for leading the steel wire rope 50 to the bottom of the wedge wheel 6, and then the friction area between the wedge wheel and the steel wire rope will be minimum to avoid it slipping similarly.

The outer component 30 and the line-guiding mechanism 4 is attached at the different sides of the outer shell 1 for avoiding the outer braking component 30 influencing the retraction of the steel wire rope 50.

If someone need to be rescued by the descent rescue device, the operating steps is following: first of all, hanging the hanging ring 22 on the building tightly and fastening the pothook of the belt on the rope ring 51, checking the assembling to be security and placating the saved man's emotion; after that, the saved man should catch up the steel wire rope, then the body should depart from the building. At present, the descent rescue device is in loading state, if the weight of loading is less than the setting weight (e.g. 29 kg), the spring traction tube 23 will keep in still. If the weight of load is greater than the setting weight, the spring traction tube 23 will bring a certain displacement. The displacement distance depends on the size of the load, that is to say, the displacement distance of the spring traction tube 23 will increase with the load increasing, and conversely the displacement distance will reduce with the load reducing. With the pulling down of the spring traction tube 23, the energy conversion spring 210 and the buffer spring 212 will be pressed to produce a certain elastic restoring force for resisting the load gravity controlling the falling speed. The energy conversion puller 25 can be pulled by the energy conversion adjusting screw 20 to drive the block closing rotation roller 310a swaying and transmitting the energy to the first friction block 310d, then the friction between the first braking block 311 and the brake hub 312 will change. If the brake hub 312 is pressed, a great friction will produce between the first braking block 311 and the brake hub 312 to transform the deformation energy of the energy conversion spring 210 and the buffer spring 212 into the mechanical energy, and then transmit the mechanical energy into the first braking block 311 by the energy conversion adjusting screw 20, so that the friction damping will be produce among the first braking block 311, the brake hub 312 and the second braking block 313 for controlling the falling speed of the saved man. That is to say, with the weight of the saved man heavier, the loading capacity would be larger and the friction damping from the inner braking component also be greater, so that the elastic restoring force from the energy conversion spring 210 and the buffer spring 212 would be greater and contrary the weight of falling down. The friction from the inner braking component and the elastic restoring force from the typa mechanism are equal to the weight of falling down, so as to keep the descent rescue device falling in uniform speed and avoid harming to the saved man in a high falling speed. With the first friction block 310d connecting the brake hub 312 and the energy conversion puller 25, the loading will make the energy conversion spring 210 deformed by pulled. The elastic deformed energy could be transformed into the mechanical energy and transmitted it to the block closing rotation roller 310a by pulling the energy conversion adjusting screw 20. With the rotation of the block closing rotation roller 310a, the friction resistance would produce between the first friction block 310d and the brake hub 312 to make the descent rescue device slow down with the mechanical energy conversion theory.

The descent rescue device also comprises the outer braking component 30 for controlling the falling speed and breaking itself. With controlling the falling speed of the saved man, the descent rescue device could be broken in any altitude of the air.

The outer braking component 30 is connecting with the inner braking component 31. With no pressure on the outer braking component 30 or the biggest pressure on it, the power handle 301 and the helping handle 302 of the outer braking component 30 would be pressed together. The pressure on the power handle 301 would be transmitted to the linkage arm 303 to pull the block closing rotation roller 310a rotating in a micro angle, so that the energy can be transmitted to the first braking block 311 and the brake hub 312 to produce a large friction between them to make the descent rescue device in braking state. That is to say, when the descent rescue device is on the initial state, it will keep braking and no falling down automatic until the saved man gets ready. Moreover, during the falling process, if the saved man releases frightened the power handle 301, the outer braking component will recover to be the braking state that the descent rescue device is not falling down continually and remain in any altitude of the air. Conversely, if the saved man holds frightened the power handle 301 and the helping handle 302 to press together, when the pressure force is the biggest, the block braking component also can transmit the pressure to the inner braking component for causing the inner braking component braking and then the descent rescue device keeping in the braking state. Whether the saved man holds the outer braking component 30 or the inner braking component 31 or not, the inner braking component 31 also could produce a large friction to stop the descent rescue device on the falling process by the different ways. Until the pressure on the outer braking component 30 is moderated, the friction would not bring from the braking hub 312 and the second braking block 313 so that the steel wire rope could be released freely and then the saved man could fall on a constant speed. At the same time, the falling speed can be adjusted by controlling the potency dimension between the power handle 301 and the helping handle 302. If the open of the power handle 301 is too small, then the falling speed will slow down, if the open of the power handle 301 is half open, then it will fall faster. The falling speed is controlled by the damp and can be adjusted according to the need, so it will not become a free-falling motion. Meanwhile, compared to prior descent rescue devices, the present descent rescue device could be stopped in any altitude of the air, avoiding more harm to people because of the great impact when landing. For people who don't have good mental qualities, the present device gives them time to be prepared to fall down, which is of great value in practical operation.

The hanging and hooking part is extended from two ends of the descent rescue device. At one end is the hanging ring 22 and the other end is rope ring 51. If someone needs to be rescued by the descent rescue device, the fireman can set the hanging ring 22 on the building, control the falling status and speed, and help the saved man fastening the pothook of the belt so he could fall at a constant speed down the steel wire rope. When it comes to the fireman, he sets the rope ring 51 on the building tightly and fastening the pothook of the belt on the hanging ring 22, and control the falling status and speed himself. And then, the descent rescue device achieves the purposes of slowing down many times back and forth from the high building by many people and controlling the falling status and speed.

On one end of the steel wire rope is the rope ring 51 and the other end is the rolled plate 52. When the first saved man land safely, the rolled plate 52 releases the rope to make the rotation of the wedge wheel 6. Cut the excess rope of the rolled plate 52 according to the height of the building; buckle up the second saved man's knot buckle provided by the descent rescue device; fasten the pothook of the belt on the rope ring, then the fireman can repeat the process of rescuing the first saved man and get the second saved man down to the ground safely. Therefore the descent rescue device achieves the purposes of slowing down many times back and forth by many people and break through the limitation of rope during high building rescue.

The braking state is achieved by multistage braking components' interaction, mutual restraint, and outer braking component 30 controlling the state of inner braking component 31. The saved man is safe even when he is in panic because the descent rescue device remains braking state whether it is on the initial state or on the biggest pressure. Only when the saved man is conscious and press the outer braking component moderately, can release the inner braking component and the steel wire rope can be released freely. At the very braking moment, load of the device resist against the friction damping inner from the braking component, the energy conversion spring and the buffer spring of the tyra mechanism produce elastic restoring force acting as a buffer to achieve the purpose of slowing down at a constant speed.

The safety requirement for descent rescue from high building is very high. Friction between mechanical components influences the accuracy a lot. Without real-time adjusting, it may affect the safety. In the present invention, to avoid accuracy declining after long time use, the spring is set to correct and adjust the position of the easily worn components through its resetting. In the mean time, the spring, which acts as a buffer, produce a certain elastic restoring force for resisting the load gravity so the saved man and fireman can slow down at a constant speed. The device both guarantees people's safety and helps overcoming their mental barrier.

The braking rocker arm and the descent rescue device can be set separately so that we can select suitable length of the steel wire rope according to the height of the building. Flexible assemblage can meet different needs and it doesn't increase the weight of the whole device, easy to carry and the structure is simple.

The descent rescue device in the present invention surpasses the operational mode of prior descent rescue devices by adopting a new design concept. It not only has advantages such as reasonable structure design, small in size, lightweight and easy to carry, but also has high safety coefficient, high controllability, better braking performance, constant speed descending, available in many back-and-forth and stopping at any altitude of the air. The present descent rescue device solves the defects which existed in prior devices such as heaviness, large size, difficult to control the state and falling speed, and unable to slow down and brake in the air. Therefore, the descent rescue device in present invention brings to the application of fire control devices a new solution of high building rescue.

1. A descent rescue device with double brake and back and forth controlled comprising an outer shell and a tyra mechanism, a wedge wheel, a double braking mechanism and a line-guiding mechanism installing inside the outer shell, wherein the tyra mechanism comprises an energy conversion adjusting screw and a buffer installed the outer thereof, which is connected to the double braking mechanism and moving together, the double braking mechanism comprises an outer braking component, an inner braking component and a locking mechanism, the inner braking component is connected to the energy conversion adjusting screw of the tyra mechanism for moving together, a wedge wheel is provided for installed the outside surface of the inner braking component, a bundle of steel wire rope is wrapped around the wedge wheel, the locking mechanism is movably resisted between the outer braking component and the outer shell, while the outer braking component in the state of no pressure or the biggest pressure, the inner braking component is to be in the state of riding the brake and producing damp in order to tighten and lock the steel wire rope wrapping around it; while the outer braking component in the state of half clutch or full open, then the inner braking component would loosen the lock of the steel wire rope because the damp and frictional resistance is weak, and then the steel wire rope would be leaded from the line-guiding mechanism easily.

2. The descent rescue device with double brake and Back and forth controlled according to claim 1, wherein when the tyra mechanism is located at the building and the free end of the steel wire rope is tied at the body who be saved, the people who be saved can drop along with the steel wire rope; when the free end of the steel wire rope is tied at the building and the tyra mechanism is tied around the body who are able to self-rescue, the people who are able to self-rescue can also drop to any place in air along with the descent rescue device.

3. The descent rescue device with double brake and Back and forth controlled according to claim 1, wherein the inner braking component comprises a main axis, the first braking block, a braking hub and the second braking block, the block closing rotation roller is connected to the energy conversion adjusting screw of the tyra mechanism, the brake hub is located between the friction block and the second braking block, during falling of the descent rescue device, the tyra mechanism is separated from the outer shell and the block linkage arm could be rotated by the pulling of the tyra mechanism, and two friction blocks located at the two side of the main axis is pressed onto the brake hub and the second braking block with an outward force, the friction of the first braking block, the brake hub and the second braking block is equal to the weight of people, the friction between the first braking block and the brake hub and the second braking block is directly proportional to the weight of people.

4. The descent rescue device with double brake and Back and forth controlled according to claim 3, wherein the center of main axis is located at middle of the shaft plate, two friction blocks is located at the two side of the main axis symmetrically, two block gap are located on the the first braking block, two friction blocks are embedded into two block gap, the two friction blocks are the first friction block and the second friction block, the first friction block is connected to the block linkage arm by the block closing rotation roller, and the block linkage arm is connected to the energy conversion adjusting screw of the tyra mechanism, during the falling of the descent rescue device, the middle part of block linkage arm drive the first friction block deflecting and making a micro-rotation in the block gap with the pulling of the energy conversion puller, in order to drive the first friction block to press the brake hub and the second braking block.

5. The descent rescue device with double brake and Back and forth controlled according to claim 3, wherein the outer braking component comprises a power handle and a helping handle, the locking mechanism is resisted between the power handle and the helping handle, the power handle is connected to the block linkage arm by the linkage arm, with no pressure on the power handle and the helping handle, the locking mechanism is resisted between the power handle and the helping handle to keep the maximum angle, the brake hub press the second braking block to make the steel wire rope wrapped around it locked, so as to lock the steel wire rope wrapped around the wedge wheel, producing braking state to stop the release of steel wire rope, with the power handle and the helping handle are pressed to compress the locking mechanism to the minimum, the power handle could drive the linkage arm swaying together to push the block closing rotation roller rotating, the first friction block is pressed to bring friction between the first friction block and the brake hub so that the descent rescue device would keep in braking, if the locking mechanism is pressed a certain space, the outer braking component will be in a half clutch state, at the same time the descent rescue device at the braking state, the steel wire rope could be released limited from the outer braking component.

6. The descent rescue device with double brake and Back and forth controlled according to claim 5, wherein the locking mechanism comprise a brake-adjusting nut, a brake-tightening spring, a braking assembly base and a brake-pushing puller which run through the hole, the brake adjusting screw is fixed on the outer shell by the brake-adjusting nut, the brake-tightening spring is provided between the brake-adjusting nut and the braking assembly base, with no pressure on the outer braking component, the brake-pushing puller is always resisted between the power handle and the helping handle by the brake-tightening spring to keep the maximum angle.

7. The descent rescue device with double brake and Back and forth controlled according to claim 1, wherein the tyra mechanism comprises the energy conversion adjusting screw, the buffer, a hanging ring, a spring traction tube and a buffer tube, the buffer comprises an energy conversion spring and a buffer spring, the energy conversion spring is received between the energy conversion adjusting screw and the spring traction tube, and the buffer spring is received between the spring traction tube and the buffer tube, the hanging ring and the energy conversion adjusting screw are to be separately each other.

8. The descent rescue device with double brake and Back and forth controlled according to claim 1, wherein the line-guiding mechanism comprises a guide wheel, a sliding briquetting and a briquetting spring, the guide wheel is assembled at the export of the outer shell, the sliding briquetting is assembled beside the guide wheel, the briquetting spring is provided for adjusting the limited of the sliding briquetting, which is inserted in the space between the in-wall of the outer shell and the sliding briquetting.

9. The descent rescue device with double brake and Back and forth controlled according to claim 3, wherein the guide angle of the wedge wheel is 25°-35° degree.

10. The descent rescue device with double brake and Back and forth controlled according to claim 1, wherein the outer component and the line-guiding mechanism is attached at the different sides of the outer shell.
